(19) United States
(12) Patent Application Publication
(10) Pub. No.: US 2025/0380343 A1
(43) Pub. Date: Dec. 11, 2025

(54) Power Supply With Integrated Dimming And Color Panel

(71) Applicant: Zhuhai Shengchang Electronics Co., Ltd., Zhuhai City (CN)

(72) Inventors: Xianyun ZHAO, Zhuhai City (CN); Jialong HU, Zhuhai City (CN); Dehua ZHENG, Zhuhai City (CN)

(73) Assignee: Zhuhai Shengchang Electronics Co., Ltd., Zhuhai City (CN)

(21) Appl. No.: 18/764,456

(22) Filed: Jul. 5, 2024

(30) Foreign Application Priority Data
Jun. 6, 2024 (CN) 2024212990389

(51) Int. Cl. H05B 45/10; H05B 45/20; H05B 47/19

(52) U.S. Cl. CPC H05B 45/10; H05B 45/20; H05B 47/19

(57) ABSTRACT

Discloses a power supply with an integrated dimming and color panel, which includes a mounting panel, a control panel, a rear housing and a dimming and color power supply module. The mounting panel is used to be fixedly connected to wall surface or cabinet surface. The control panel is arranged on the mounting panel, and a front of the control panel is provided with a control switch, a color temperature control mechanism and a brightness control mechanism. The dimming and color power supply module is arranged in a cavity formed by the rear housing and the mounting panel, and is electrically connected to the control switch, the color temperature control mechanism, the brightness control mechanism, the input end and the output end. This power supply can achieve color temperature and brightness control of the light source without external dimming signals of color temperature and brightness, and is easy to install.

### TECHNICAL FIELD

The present disclosure herein relates to the technical field of dimming power supplies, and in particular to a power supply with an integrated dimming and color panel.

### BACKGROUND

With the improvement of people's living standards, Light-Emitting Diode (LED) light sources have increasingly become the preferred choice for indoor and outdoor lighting for the majority of users. The LED light source can adjust the brightness and color temperature through a dimming power supply to achieve a variety of different lighting effects. In order to adjust the brightness and color temperature of the existing dimming power supply, it is necessary to connect external dimming signals of brightness and color temperature, such as 0-10 V dimming signal or Digital Addressable Lighting Interface (DALI) dimming signal. The former requires the installation of two dimmers to achieve brightness and color temperature adjustment, and the power supply also requires two sets of dimming signal processing circuits. The wiring cost and the cost of dimmers and power supply are relatively high, and additional installation space needs to be configured during installation. The latter requires at least one dimming controller and a bus power supply to achieve color temperature and color control, which is more expensive. For this reason, it is necessary to design a brightness and color temperature adjustment scheme for LED light sources that is easy to install and use and has low implementation cost.

### SUMMARY

In order to overcome the shortcomings of the prior art, the purpose of the present disclosure is to provide a power supply with an integrated dimming and color panel. A control panel with a brightness control mechanism and a color temperature control mechanism is integrated on the dimming power supply, which can adjust the brightness and color temperature of the light source without the need for external dimming signals of brightness and color temperature. It can be directly installed on the wall or cabinet surface through the mounting panel, making installation and use convenient.

In order to solve the above problems, the technical solution adopted by the present disclosure is as follows: a power supply with an integrated dimming and color panel, including: a mounting panel, wherein the mounting panel is used to be fixedly connected to wall surface or cabinet surface; a control panel, wherein the control panel is arranged on the mounting panel, a front of the control panel is provided with a control switch, a color temperature control mechanism and a brightness control mechanism, and the color temperature control mechanism and the brightness control mechanism are used for inputting electrical signals for color temperature adjustment and brightness adjustment, respectively; a rear housing, wherein the rear housing is detachably connected to the mounting panel, and a surface of the rear housing is provided with a via hole for an input end and an output end to pass through; and a dimming and color power supply module, wherein the dimming and color power supply module is arranged in a cavity formed by the rear housing and the mounting panel, and is electrically connected to the control switch, the color temperature control mechanism, the brightness control mechanism, the input end and the output end; and the dimming and color power supply module is used to adjust an electrical energy input from the input end to a required value based on the electrical signals input by the control switch, the color temperature control mechanism, and the brightness control mechanism, and then output the electrical energy to a light source from the output end.

Compared with the prior art, the beneficial effect of the present disclosure is that by installing the dimming and color power supply module into the rear housing arranged on a back side of the mounting panel, there is no need to configure an installation space for the dimming and color power supply module during installation and use, making it easy to install. The control panel is arranged on the mounting panel, and a color temperature control mechanism and a brightness control mechanism are arranged on the control panel. The brightness and color temperature of the light source can be adjusted and controlled without external dimming signals. The dimming and color power supply module is directly arranged on the back of the control panel and can be electrically connected to the internal wiring of the control switch, color temperature control mechanism and brightness control mechanism on the control panel in advance. There is no need for the user to wire between the control panel and dimming and color power supply module during installation and use, further reducing the difficulty of installation. At the same time, the color temperature control mechanism and brightness control mechanism are close to the dimming and color power supply module. The electrical signals input through the color temperature control mechanism and brightness control mechanism are basically not subject to interference and attenuation, and there is no need to convert them into specific forms of dimming signals for extended transmission distances, thus avoiding the necessity to install a dimming signal processing circuit in the dimming and color power supply module, which in turn reduces the cost of the dimming and color power supply.

The above-mentioned power supply with the integrated dimming and color panel, wherein both the color temperature control mechanism and the brightness control mechanism comprise a potentiometer and an adjustment mechanism; the adjustment mechanism is arranged on the front of the control panel, the potentiometer is arranged on the mounting panel, and the potentiometer is electrically connected to the dimming and color power supply module; and the adjustment mechanism is connected to a brush handle of the potentiometer, and the adjustment mechanism is used to adjust a position of the brush handle.

The above-mentioned power supply with the integrated dimming and color panel, wherein the potentiometer is a sliding potentiometer, and the adjustment mechanism comprises a guiding groove and a push rod; the guiding groove is arranged on a back side of the control panel, and a surface of the control panel is provided with a limiting waist-shaped hole that communicates with the guiding groove; a strip-shaped hole is arranged on the mounting panel, allowing the brush handle of the potentiometer to protrude out; an adjustment handle is arranged on a front end surface of the push rod, and a handle slot matching the brush handle is arranged on a rear end surface of the push rod; and the brush handle passes through the strip hole and snaps into the handle slot, the push rod is arranged in the guiding groove and is capable of sliding along the guiding groove, and the adjustment handle passes through the limiting waist-shaped hole and extends out to a front side of the control panel.

The above-mentioned power supply with the integrated dimming and color panel, wherein a width of the push rod and the adjustment handle is wider than a width of the limiting waist-shaped hole, and a width of the connection portion between the adjustment handle and the push rod matches the width of the limiting waist-shaped hole; and the limiting waist-shaped holes of both the color temperature control mechanism and the brightness control mechanism are arranged at an edge of the control panel.

The above-mentioned power supply with the integrated dimming and color panel, wherein both the color temperature control mechanism and the brightness control mechanism are touch sliders, and the control switch is a touch switch.

The above-mentioned power supply with the integrated dimming and color panel, wherein the control switch is a rocker switch, comprising a rocker mechanism and a micro switch; and a switch slot is arranged on the mounting panel, the micro switch is clamped in the switch slot, and one end of a switch panel of the rocker mechanism is provided with a triggering portion that is capable of pressing down a spring piece of the micro switch.

The above-mentioned power supply with the integrated dimming and color panel, wherein both ends of the control panel are provided with buckles, a buckle hole that matches the buckle is arranged on the mounting panel, and the control panel is detachably connected to the mounting panel by snapping the buckle into the corresponding buckle hole.

The above-mentioned power supply with the integrated dimming and color panel, wherein the dimming and color power supply module comprises a switching power supply unit, a control unit and an output adjustment unit; an input end of the switching power supply unit is electrically connected to the input end, and an output end of the switching power supply unit is electrically connected to an input end of the output adjustment unit and the control unit, respectively; an output end of the output adjustment unit is electrically connected to the output end, the control unit is electrically connected to a control end of the output adjustment unit, the control unit is electrically connected to the color temperature control mechanism and the brightness control mechanism, and the control switch is connected in series between the input end and the switching power supply unit or is electrically connected to the control unit.

The above-mentioned power supply with the integrated dimming and color panel, wherein the output adjustment unit comprises a plurality of output adjustment circuits; an input end of each output adjustment circuit is electrically connected to the input end of the switching power supply unit, and output ends of the plurality of output adjustment circuits are electrically connected to a plurality of control pins of the control unit in a one-to-one correspondence, respectively; and the output end comprises a common line and a plurality of voltage output wires, the common line is grounded, and the plurality of the voltage output wires are electrically connected to output ends of the plurality of output adjustment circuits in a one-to-one correspondence, respectively.

The above-mentioned power supply with the integrated dimming and color panel, wherein the output adjustment unit comprises a plurality of output adjustment circuits; an input end of each output adjustment circuit is electrically connected to the input end of the switching power supply unit, and output ends of the plurality of output adjustment circuits are electrically connected to a plurality of control pins of the control unit in a one-to-one correspondence, respectively; and the output end comprises a plurality of voltage output ends, and the plurality of the voltage output ends are electrically connected to output ends of the plurality of output adjustment circuits in a one-to-one correspondence, respectively.

The above-mentioned power supply with the integrated dimming and color panel, wherein the dimming and color power supply module further comprises a wireless control unit, and the wireless control unit is electrically connected to the control unit.

The present disclosure will be further described in detail below in conjunction with the accompanying drawings and specific embodiments.

### BRIEF DESCRIPTION OF THE DRAWINGS

FIG. 1 is a three-dimensional structural diagram of a power supply with an integrated dimming and color panel according to the first embodiment of the present disclosure;

FIG. 2 is a rear view of a power supply with an integrated dimming and color panel according to the first embodiment of the present disclosure;

FIG. 3 is an internal structural diagram of a power supply with an integrated dimming and color panel according to the first embodiment of the present disclosure;

FIG. 4 is a rear view of a control panel according to the first embodiment of the present disclosure;

FIG. 5 is a rear view of a mounting panel according to the first embodiment of the present disclosure;

FIG. 6 is a functional block diagram of a dimming and color power supply module according to the first embodiment of the present disclosure;

FIG. 7 is a functional block diagram of a dimming and color power supply module according to the second embodiment of the present disclosure; and

FIG. 8 is an exploded structural view of a power supply with an integrated dimming and color panel according to the second embodiment of the present disclosure.

### DETAILED DESCRIPTION OF THE EMBODIMENTS

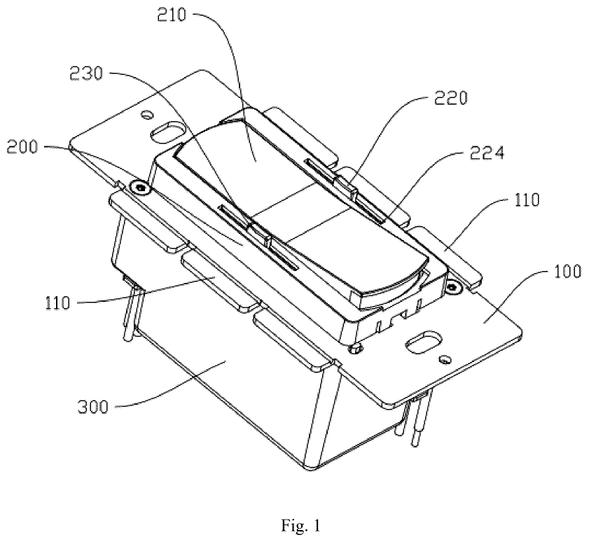

The following is detailed description of embodiments of the present disclosure. Referring to FIGS. 1 to 3, an embodiment of the present disclosure provides a power supply with an integrated dimming and color panel, including a mounting panel 100, a control panel 200, a rear housing 300 and a dimming and color power supply module 400. The mounting panel 100 is used to be fixedly connected to wall surface or cabinet surface to realize the fixed installation of the power supply with the integrated dimming and color panel. The control panel 200 is arranged on the mounting panel 100, a front of the control panel 200 is provided with a control switch 210, a color temperature control mechanism 220 and a brightness control mechanism 230, and the color temperature control mechanism 220 and the brightness control mechanism 230 are used for inputting electrical signals for brightness adjustment and color temperature adjustment, respectively. The rear housing 300 is detachably connected to the mounting panel 100, and a surface of the rear housing 300 is provided with a via hole for an input end 310 and an output end 320 to pass through. The dimming and color power supply module 400 is arranged in a cavity formed between the rear housing 300 and the mounting panel 100. The dimming and color power supply module 400 is electrically connected to the control switch 210, the color temperature control mechanism 220, the brightness control mechanism 230, the input end 310 and the output end 320; and the dimming and color power supply module 400 is used to adjust an electrical energy input from the input end 310 to a required value based on the electrical signals input by the control switch 210, the color temperature control mechanism 220, and the brightness control mechanism 230, and then output the electrical energy to a light source from the output end 320.

According to the power supply with the integrated dimming and color panel in the embodiment of the present disclosure, the dimming and color power supply module 400 is arranged in the cavity between the rear housing 300 and the mounting panel 100, thus eliminating the need to provide a separate installation space for the dimming power supply. And by integrating the control panel 200 on the mounting panel 100; the control switch 210, the color temperature control mechanism 220 and the brightness control mechanism 230 are arranged on the control panel 200; and the control switch 210, the color temperature control mechanism 220 and the brightness control mechanism 230 can be electrically connected to the dimming and color power supply module 400 through the internal wiring. There is no need for additional wiring between the power supply and the control panel 200 during installation, which is convenient for installation and use, and can reduce installation and implementation costs. At the same time, the color temperature and brightness of the LED light source can be independently controlled without the need for external dimming signals for color temperature and brightness. The color temperature control mechanism 220 and the brightness control mechanism 230 are close to the dimming and color power supply module 400, and are connected by internal wiring. The electrical signals between them are basically not attenuated or interfered, and can be directly connected to the analog input pin of the control unit in the dimming and color power supply module 400, eliminating the need for a dimming signal processing circuit within the module, thus reducing the cost of the dimming power supply.

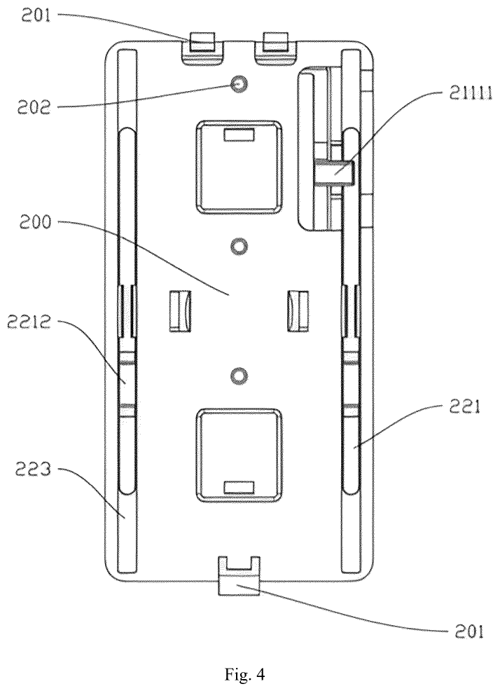

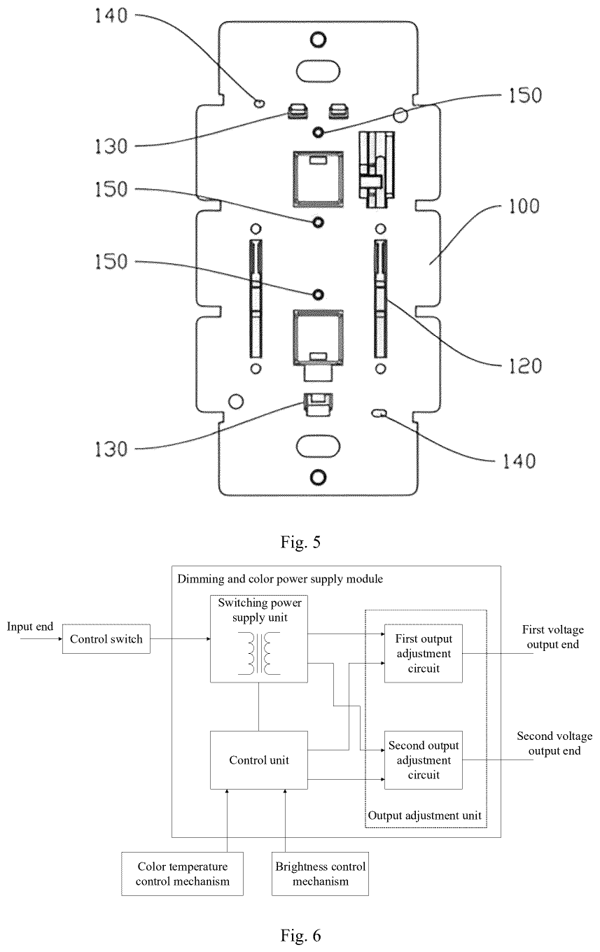

Referring to FIGS. 4 and 5, in this embodiment, in order to facilitate the maintenance and replacement of the control panel 200, the control panel 200 is detachably connected to the mounting panel 100 by means of buckles 201. Buckles 201 are arranged at the upper and lower ends of the control panel 200, and buckle holes 130 are arranged at corresponding positions of the mounting panel 100. The control panel 200 can be fixedly connected to the mounting panel 100 by snapping the buckles 201 into the buckle holes 130. The number of buckles 201 at both ends of the control panel 200 is inconsistent to prevent the control panel 200 from being installed upside down. Referring to FIG. 4, in order to facilitate the installation and disassembly of the control panel 200, a gap is arranged between the peripheral side of the buckle 201 on at least one end of the control panel 200 and the main body of the control panel 200, which facilitates prying the buckle 201 to deform it inward during installation or disassembly, and the hook of the buckle 201 is separated from the edge of the buckle hole 130, achieving the engagement and detachment of the buckle 201 and the buckle hole 130. A plurality of panel positioning columns 202 are arranged at the bottom of the control panel 200. Panel positioning holes 150 matching the panel positioning columns 202 are arranged on the mounting panel 100. When the control panel 200 is installed on the mounting panel 100, the panel positioning columns 202 will extend into the corresponding panel positioning holes 150 and ensure the relative positioning accuracy between the control panel 200 and the mounting panel 100. In this embodiment, the mounting panel 100 and the rear housing 300 are connected by bolts, housing positioning holes 140 for positioning the rear housing 300 are arranged on the mounting panel 100, and the upper edge of the rear housing 300 is provided with shell positioning columns that match the housing positioning holes 140 to facilitate the pre-positioning when the mounting panel 100 is connected to the rear housing 300 with bolts. Referring to FIG. 5, two housing positioning holes 140 are arranged at a pair of opposite corners of the mounting panel 100, respectively. The size of the two housing positioning holes 140 is inconsistent to prevent the rear housing 300 from being installed upside down.

It can be understood that the color temperature control mechanism 220 and the brightness control mechanism 230 are generally composed of a potentiometer 222 and an adjustment mechanism. The potentiometer 222 is electrically connected to the dimming and color power supply module 400. The adjustment mechanism is arranged on the control panel 200, and the adjustment mechanism is connected to a brush handle 2221 of the potentiometer 222. The brush handle 2221 of the potentiometer 222 is generally not convenient for human hands to hold. The adjustment mechanism serves as a detachable extension structure of the brush handle 2221 that is easy to hold, providing convenience for the user to adjust the position of the brush of the potentiometer 222. The color temperature control mechanism 220 and the brightness control mechanism 230 are composed of an adjustment mechanism and a potentiometer 222, which also facilitates the user's maintenance and modification of the color temperature control mechanism 220 and the brightness control mechanism 230, and potentiometers 222 with different resistances and resolutions can be replaced to meet the needs of different LED light sources without modifying the layout of the control panel 200. Alternatively, when the adjustment mechanism is damaged, only the adjustment mechanism can be replaced to reduce maintenance costs. The potentiometer 222 can be a rotary potentiometer 222 or a sliding potentiometer 222. Correspondingly, the adjustment mechanism can also be a knob or a slider.

Referring to FIGS. 3 and 4, in this embodiment, the potentiometer 222 is a sliding potentiometer 222. The potentiometer 222 is installed on the back side of the mounting panel 100 through bolts. The mounting panel 100 is provided with a strip hole 120. The brush handle 2221 of the potentiometer 222 can pass through the strip hole 120 and extend out to a front side of the mounting panel 100. The adjustment mechanism includes a push rod 221 and a guiding groove 223. An adjustment handle 2211 is arranged on a front end surface of the push rod 221, and a handle slot 2212 is arranged on a rear end surface of the push rod 221. The guiding groove 223 is arranged on the back side of the control panel 200. A limiting waist-shaped hole 224 connected with the guiding groove 223 is arranged on the surface of the control panel 200. The push rod 221 is arranged in the guiding groove 223 and can slide along the guiding groove 223. The adjustment handle 2211 can pass through the limiting waist-shaped hole 224 and extend out to the front side of the control panel 200. The limiting waist-shaped hole 224 limits the stroke of the push rod 221. The brush handle 2221 can be snapped into the handle slot 2212 after passing through the strip-shaped hole 120, so that when the push rod 221 moves, it can drive the brush handle 2221 of the potentiometer 222 to move together to adjust the resistance of the potentiometer 222, thereby controlling the output of the dimming and color power supply module 400 to realize the adjustment of the brightness or color temperature of the LED light source.

Referring to FIG. 1, in order to avoid misoperation, in this embodiment, the color temperature control mechanism 220 and the brightness control mechanism 230 are arranged on both sides of the control switch 210, respectively. Two limiting waist-shaped holes 224 are arranged in the center of the control panel 200 to facilitate user operation. Referring to FIG. 3, the adjustment handle 2211 and the handle slot 2212 are offset in the length direction of the push rod 221, allowing the potentiometer 222 and the limiting waist-shaped hole 224 to be positioned without alignment. This ensures the beautiful and convenient layout of the color temperature control mechanism 220 and the brightness control mechanism 230, while simultaneously avoiding insufficient utilization of space inside the control panel 200. Thereby, the structure of the entire integrated dimming and color panel power supply is made more compact. The front end surface of the adjustment handle 2211 is an arc surface that is concave toward the rear side, conforming to the contour of the fingers, making it easier for the user to push the adjustment handle 2211.

Referring to FIG. 1, in order to prevent the push rod 221 from coming out of the control panel 200, the width of the adjustment handle 2211 and the width of the main body of the push rod 221 are wider than the width of the limiting waist-shaped hole 224. The width of the connecting portion between the adjustment handle 2211 and the main body of the push rod 221 matches the width of the limiting waist-shaped hole 224. The limiting waist-shaped hole 224 should be arranged close to the edge of the control panel 200, so that at least one side wall of the limiting waist-shaped hole 224 has a narrower thickness and is easier to deform, allowing the wider adjustment handle 2211 to pass through the limiting waist-shaped hole 224.

Referring to FIG. 3, in this embodiment, the control switch 210 is a rocker switch, including a rocker mechanism 211 and a micro switch 212. A switch slot is arranged on the mounting panel 100, and the micro switch 212 is clamped in the switch slot via the switch base 2121. A through hole is provided on the rear end surface of the switch base 2121 for the pin of the micro switch 212 to pass through. The structure of the rocker mechanism 211 is common knowledge in the art, and its specific structure will not be described again here. One end of the switch panel of the rocker mechanism 211 is provided with a triggering portion 2111 for pressing down a triggering portion 2111 of a spring piece of the micro switch 212. A through hole is arranged on the control panel 200 for the triggering portion 2111 to pass through. When one end of the switch panel, which is close to the micro switch 212, is pressed down, the micro switch 212 is closed.

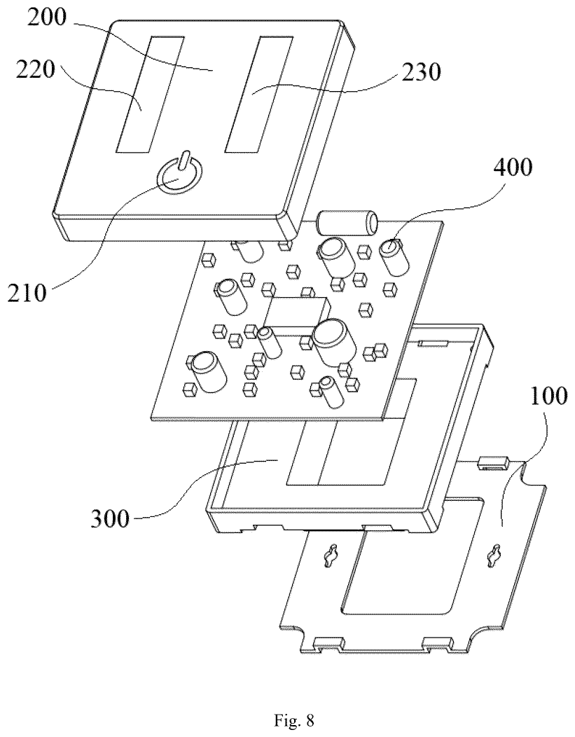

Referring to FIG. 8, in some embodiments, the color temperature control mechanism 220 and the brightness control mechanism 230 may also use touch sliders, and the control switch 210 may use a touch switch. The two touch sliders and touch switch can be composed of two long strip-shaped capacitive touch buttons and a square capacitive touch button respectively, or two strip-shaped virtual slider modules and a square virtual slider button can be arranged on a touch screen respectively. Text or graphic logos should be arranged on the two touch sliders and the touch panel of the touch switch respectively to allow users to distinguish functions. Gradient color blocks from warm to cold colors should be arranged on the touch slider of the color temperature control mechanism 220 to guide the user to adjust the sliding direction between warm and cold colors. Gradient color blocks from light to dark should be arranged on the touch slider of the brightness control mechanism 230 to guide the user to adjust the sliding direction between bright and dark. The touch slider and touch switch can be set with the backlight for night use. The backlight of the touch switch may include red or green colors to indicate the on/off status of the LED light source.

Referring to FIGS. 1 and 6, in order to further facilitate the installation of the integrated dimming light source, a plurality of outer edge positioning flanges 110 are arranged on the edge of the mounting panel 100, and gaps are arranged between adjacent positioning flanges 110. A positioning slot is arranged at the connection between the positioning flange 110 and the mounting panel 100. The direction of the positioning slot is parallel to the direction of the edge where the positioning flange 110 is locked, making it convenient to pre-fix the installation position when installing on a wall or cabinet surface by coordinating with the slot or bolt on the lining board.

It can be understood that the dimming and color power supply module 400 includes a switching power supply unit, a control unit and an output adjustment unit. An input end of the switching power supply unit is electrically connected to the input end 310, and the output end is electrically connected to an input end of the output adjustment unit and the control unit, and is used to provide a reference voltage for the output adjustment unit and provide power for the operation of the control unit. The control unit is electrically connected to the potentiometer 222 in the color temperature control mechanism 220 and the brightness control mechanism 230, and is electrically connected to a control end of the output adjustment unit. The adjustment of the brightness or color temperature of the LED light source can be achieved by adjusting the output of the output adjustment unit according to the change in resistance of potentiometer 222. An output end of the output adjustment unit is connected to the output end 320, and is connected to the LED light source through the output end 320, for adjusting the power of the electric energy output to the LED light source according to the control signal sent by the control unit. The control switch 210 can be connected in series between the input end 310 and the switching power supply unit, directly controlling the connection between the entire integrated dimming light source and the mains power to realize the switching of the LED light source; or it can be electrically connected to the control unit, feeding back the switch status to the control unit, and allowing the control unit to control the output of the output adjustment unit based on the switch status, thus achieving on/off control of the LED light source. It can be understood that the output adjustment unit is generally a Direct Current (DC)/DC conversion circuit. The specific circuit structures of the output adjustment unit, switching power supply unit and control unit are common knowledge in the art and will not be described again here.

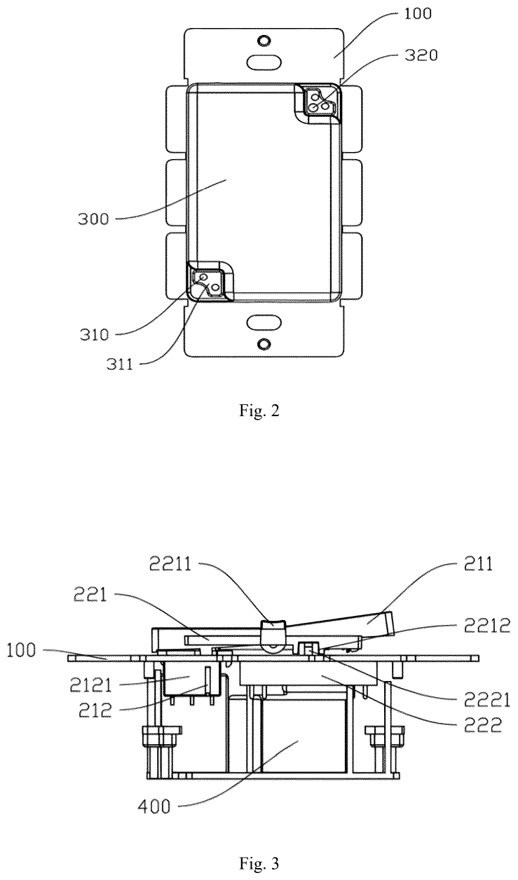

In some embodiments, some LED light sources have dual color temperature or multi-color temperature functions, and accordingly, the output adjustment unit has at least two output adjustment circuits. Referring to FIG. 6, in this embodiment, the output adjustment unit has two output adjustment circuits. The input ends of the two output adjustment circuits are connected to the output ends of the switching power supply unit. The control ends of the two output adjustment circuits are connected to the two independent control pins of the control unit respectively. It can be understood that the input end 310 and the output end 320 can be terminals or wires. Referring to FIG. 2, in this embodiment, the input end 310 and the output end 320 are wires. The wires of the input end 310 and the output end 320 enter and exit the rear housing 300 through a wire sleeve 311 to protect the wires from being cut by the edge of the rear housing 300. The input end 310 includes a neutral wire and a live wire, and the output end 320 includes a common line and two voltage output wires. The common line is grounded or connected to the positive pole of the output. The common line is grounded or connected to the positive terminal of the output, and the two voltage output wires are electrically connected to the output ends of the two output adjustment circuits in a one-to-one correspondence.

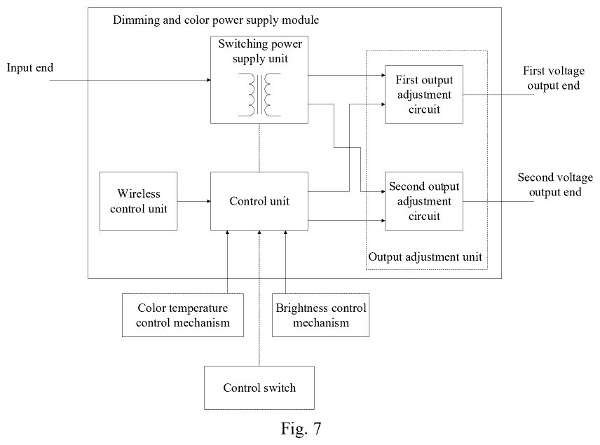

In some embodiments, in order to further facilitate the adjustment and control of the color temperature and brightness of the LED light source, referring to FIG. 7, the dimming and color power supply module 400 also includes a wireless control unit. The wireless control unit can be a Wi-Fi unit or Narrow Band Internet of Things (NB-IoT) unit, etc., the wireless control unit is electrically connected to the control unit, and the color temperature and brightness dimming signals can be sent to the control unit via the wireless control unit using terminal devices such as mobile phones. The control priority between the wireless control unit, the color temperature control mechanism 220 and the brightness control mechanism 230 can be set according to actual needs, or it can be based on the most recent change in control method.

It should be noted that, in the description of the present disclosure, any references to orientation, such as “up”, “down”, “front”, “back”, “left”, “right”, etc., are based on the orientation or positional relationships depicted in the accompanying drawings. These references are solely for the convenience of describing the present disclosure and simplifying the description. They do not indicate or imply that the device or element referred must have a specific orientation, be constructed or operated in a particular orientation, and should not be construed as a limitation of the present disclosure.

In the description of the present disclosure, “a plurality of” shall refer to one or more, “multiple” shall refer to two or more, and expressions such as “greater than,” “less than,” “exceed,” etc., shall be understood as excluding the stated number. Expressions such as “above,” “below,” “within,” etc., shall be understood as including the stated number. If references to “first” or “second” are made, they are merely for the purpose of distinguishing technical features, and should not be understood to indicate or imply relative importance, or implicitly specify the number of technical features being referred to, or imply any order of precedence among the technical features.

In the description of the present disclosure, unless otherwise explicitly limited, words such as “provided with”, “install”, and “connect” should be understood in a broad sense. Those skilled in the art can reasonably determine the specific meaning of the above words in the present disclosure in combination with the specific content of the technical solution.

The above-mentioned embodiments are only preferred embodiments of the present disclosure and cannot be used to limit the scope of protection of the present disclosure. Any non-substantive changes and substitutions made by those skilled in the art on the basis of the present disclosure shall belong to the scope of protection claimed by the present disclosure.

What is claimed is:

1. A power supply with an integrated dimming and color panel, comprising:
a mounting panel, wherein the mounting panel is used for fixed connection with wall surface or cabinet surface;
a control panel, wherein the control panel is arranged on the mounting panel, a front of the control panel is provided with a control switch, a color temperature control mechanism and a brightness control mechanism, and the color temperature control mechanism and the brightness control mechanism are used for inputting electrical signals for color temperature adjustment and brightness adjustment, respectively;
a rear housing, wherein the rear housing is detachably connected to the mounting panel, and a surface of the rear housing is provided with a via hole for an input end and an output end to pass through; and
a dimming and color power supply module, wherein the dimming and color power supply module is arranged in a cavity formed by the rear housing and the mounting panel, and is electrically connected to the control switch, the color temperature control mechanism, the brightness control mechanism, the input end and the output end; and the dimming and color power supply module is used to adjust an electrical energy input from the input end to a required value based on the electrical signals input by the control switch, the color temperature control mechanism, and the brightness control mechanism, and then output the electrical energy to a light source from the output end.

2. The power supply with the integrated dimming and color panel according to claim 1, wherein both the color temperature control mechanism and the brightness control mechanism comprise a potentiometer and an adjustment mechanism; the adjustment mechanism is arranged on the front of the control panel, the potentiometer is arranged on the mounting panel, and the potentiometer is electrically connected to the dimming and color power supply module; and the adjustment mechanism is connected to a brush handle of the potentiometer, and the adjustment mechanism is used to adjust a position of the brush handle.

3. The power supply with the integrated dimming and color panel according to claim 2, wherein the potentiometer is a sliding potentiometer, and the adjustment mechanism comprises a guiding groove and a push rod; the guiding groove is arranged on a back side of the control panel, and a surface of the control panel is provided with a limiting waist-shaped hole that communicates with the guiding groove; a strip-shaped hole is arranged on the mounting panel, allowing the brush handle of the potentiometer to protrude out; an adjustment handle is arranged on a front end surface of the push rod, and a handle slot matching the brush handle is arranged on a rear end surface of the push rod; and the brush handle passes through the strip hole and snaps into the handle slot, the push rod is arranged in the guiding groove and is capable of sliding along the guiding groove, and the adjustment handle passes through the limiting waist-shaped hole and extends out to a front side of the control panel.

4. The power supply with the integrated dimming and color panel according to claim 3, wherein a width of the push rod and the adjustment handle is wider than a width of the limiting waist-shaped hole, and a width of the connection portion between the adjustment handle and the push rod matches the width of the limiting waist-shaped hole; and the limiting waist-shaped holes of both the color temperature control mechanism and the brightness control mechanism are arranged at an edge of the control panel.

5. The power supply with the integrated dimming and color panel according to claim 1, wherein both the color temperature control mechanism and the brightness control mechanism are touch sliders, and the control switch is a touch switch.

6. The power supply with the integrated dimming and color panel according to claim 1, wherein the control switch is a rocker switch, comprising a rocker mechanism and a micro switch; a switch slot is arranged on the mounting panel, the micro switch is clamped in the switch slot, and one end of a switch panel of the rocker mechanism is provided with a triggering portion that is capable of pressing down a spring piece of the micro switch.

7. The power supply with the integrated dimming and color panel according to claim 1, wherein both ends of the control panel are provided with buckles, a buckle hole that matches the buckle is arranged on the mounting panel, and the control panel is detachably connected to the mounting panel by snapping the buckle into the corresponding buckle hole.

8. The power supply with the integrated dimming and color panel according to claim 1, wherein the dimming and color power supply module comprises a switching power supply unit, a control unit and an output adjustment unit; an input end of the switching power supply unit is electrically connected to the input end, and an output end of the switching power supply unit is electrically connected to an input end of the output adjustment unit and the control unit, respectively; an output end of the output adjustment unit is electrically connected to the output end, the control unit is electrically connected to a control end of the output adjustment unit, the control unit is electrically connected to the color temperature control mechanism and the brightness control mechanism, and the control switch is connected in series between the input end and the switching power supply unit or is electrically connected to the control unit.

9. The power supply with the integrated dimming and color panel according to claim 8, wherein the output adjustment unit comprises a plurality of output adjustment circuits; an input end of each output adjustment circuit is electrically connected to the input end of the switching power supply unit, and output ends of the plurality of output adjustment circuits are electrically connected to a plurality of control pins of the control unit in a one-to-one correspondence, respectively; and the output end comprises a plurality of voltage output ends, and the plurality of the voltage output ends are electrically connected to output ends of the plurality of output adjustment circuits in a one-to-one correspondence, respectively.

10. The power supply with the integrated dimming and color panel according to claim 8, wherein the dimming and color power supply module further comprises a wireless control unit, and the wireless control unit is electrically connected to the control unit.
